(19) United States
(12) Patent Application Publication
(10) Pub. No.: US 2013/0156212 A1
(43) Pub. Date: Jun. 20, 2013

(54) METHOD AND ARRANGEMENT FOR NOISE REDUCTION

(71) Applicants: Adis Bjelosevic, Malmo (SE); Peter Isberg, Lund (SE); Thomas Karlsson, Lund (SE)

(72) Inventors: Adis Bjelosevic, Malmo (SE); Peter Isberg, Lund (SE); Thomas Karlsson, Lund (SE)

(21) Appl. No.: 13/679,100

(22) Filed: Nov. 16, 2012

Related U.S. Application Data
(60) Provisional application No. 61/576,385, filed on Dec. 16, 2011.

(51) Int. Cl. G10K 11/16

(52) U.S. Cl. CPC G10K 11/16
USPC 381/71.1

(57) ABSTRACT

An object of the present invention is to improve the functionality of a noise reducer adapted to perform an active noise reduction process.

The object is achieved by a noise reducer 300 comprising at least one microphone 310 connected to a noise controller 320, and at least one loudspeaker 330 connected to the noise controller 320. The microphone 310 is arranged at the loudspeaker 330, and the noise controller 320 is adapted to perform an active noise reduction process. An event detector 340 is connected to the noise controller 320 and adapted to send an event 10 detection signal to the noise controller 320, wherein the event detection signal comprises information regarding an external event. The noise controller 320 is further adapted to analyse the event detection signal and to adapted to control the active noise reduction process in dependence of an outcome of the analysis of the event detection signal.

### CROSS-REFERENCE TO RELATED APPLICATION

This application claims priority under 35 U.S.C. § 119, based on U.S. Provisional Patent Application No. 61/576,385, filed Dec. 16, 2011, the disclosure of which is hereby incorporated by reference herein.

### TECHNICAL FIELD

Embodiments here in relates to a method and device for communications in general and in particular to a method and a device for noise reduction.

### BACKGROUND

Today's urban environment often includes a lot of noise. This noisy environment may occur both indoor and outdoor, as well as in vehicles, and is usually experienced by a user as disturbing. One way to decrease the noise is by using passive hearing protectors.

One way to further decrease the noise could be to perform active noise reduction. Active noise reduction may be used in combination with passive hearing protectors. FIGS. 1a-c illustrates the principles of active noise reduction. FIG. 1a illustrates a first acoustic wave, in this case a triangle wave. This is the acoustic wave that is experienced as noise by a user and should be reduced or even canceled out. A noise reducer records the first acoustic wave e.g. by a microphone and retransmits the first acoustic wave via e.g. a loudspeaker with the same amplitude, but with inverted phase. This inverted acoustic wave is called the second acoustic wave. FIG. 1b illustrates the second acoustic wave transmitted by the noise reducer. The first acoustic wave and the second acoustic wave are combined and cancel each other out at the place where the active noise reduction is performed, e.g. the ear of the user. FIG. 1c illustrates that the first and the second acoustic waves have cancelled each other out completely. To correctly estimate the first acoustic wave at the user's ear, the microphone is preferably placed close to the ear. It is also preferred that the loudspeaker is placed close to the ear of the user. If active noise reduction is performed it is advantageous to have one microphone and one loudspeaker close to each ear.

Modern headsets or portable hands frees enables the user to listen to music and other media and also allows binaural recording. The portable hands frees may also have an active noise reduction function.

FIG. 2 illustrates a noise reducer 200 according to prior art, adapted to perform a noise reduction process. A microphone 210 is connected to a noise controller 220. The noise controller 220 is further connected to a loudspeaker 230. The noise reducer may comprise several microphones 210 connected to the noise controller 220.

A first signal e.g. the first acoustic wave is recorded by the microphone 210 or any other kind or recording means. The recorded first signal is forwarded to the noise controller 220. The noise controller 220 is adapted to analyze the recorded first signal. The noise controller 220 is adapted to analyze the first recorded signal based on the physical location of the microphone 210, the physical location of the loudspeaker 230 and physical location of the ear of the user. The noise controller 220 is further adapted to send a second signal e.g. the second acoustic wave to the loudspeaker. The second signal is a phase inversion of the first recorded signal. The noise controller 220 is further adapted to send the second signal to the loudspeaker 230 with a timing in dependence of the analyze above.

A problem with prior art is that the noise reducer reduces ambient sounds in general and the user is not aware of important sounds in the surrounding environment.

### SUMMARY

An object of the present embodiments is to provide an improved noise reducer.

In accordance with a first aspect the object is achieved by a noise reducer comprising at least one microphone connected to a noise controller, and at least one loudspeaker connected to the noise controller. The microphone is arranged at the loudspeaker, and the noise controller is adapted to perform an active noise reduction process. An event detector is connected to the noise controller and adapted to send an event detection signal to the noise controller. The event detection signal comprises information regarding an external event. The noise controller is further adapted to analyse the event detection signal and adapted to control the active noise reduction process in dependence of an outcome of the analysis of the event detection signal.

In accordance with a second aspect the object is achieved by a method in a noise reducer for controlling an active noise reduction process is provided. The noise reducer comprises at least one microphone connected to a noise controller, and at least one loudspeaker connected to the noise controller. The microphone is arranged at the loudspeaker, and the noise controller is adapted to perform the active noise reduction process. An event detection signal is received from an event detector, wherein the event detection signal comprises information regarding an external event. The noise controller is adapted to control the active noise reduction process in dependence of an outcome of an analysis of the event detection signal.

In accordance with a third aspect the object is achieved by a computer program product is provided. The computer program is loadable into a memory of a computer and comprising software code portions adapted for realizing one or more of the features of the noise reducer and/or performing one or more actions of the method.

Since the noise controller is adapted to receive the event detection signal and adapt the noise reduction process in dependence of the analysis of the event detection signal, the noise reducer is able to adapt the noise reduction process and turn it on or off so the user is able to hear the background noise if the event detection signal indicates that there's important information there for the user.

An advantage with embodiments herein is that the user is able to hear important information in the background noise if it is indicated in the event detection signal that there's important information there.

A further advantage with embodiments herein is that the user can user an application connected to the noise reducer and connect the benefits of both the application and the noise reducer.

### BRIEF DESCRIPTION OF THE DRAWINGS

Examples of embodiments herein are described in more detail with reference to attached drawings in which:

FIGS. 1a-1c is an illustration of acoustic waves in relation to a noise reducer according to prior art;

FIG. 2 is a schematic block diagram of a noise reducer according to prior art;

FIG. 3 is a schematic block diagram illustrating embodiments of a noise reducer; and

FIG. 4 is a flowchart depicting embodiments of a method in a noise reducer.

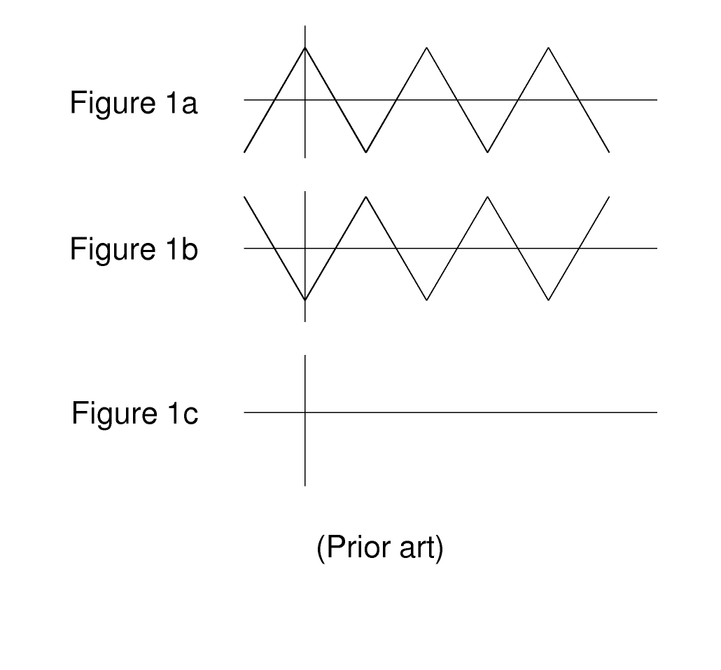

### DETAILED DESCRIPTION

Embodiments will be exemplified in a non-limiting description.

FIG. 3 illustrates a schematic block diagram of a noise reducer 300 according to some embodiments. A microphone 310 is connected to a noise controller 320. The noise controller 320 is further connected to a loudspeaker 330. An event detector 340 is connected to the microphone 310 and to the noise controller 320. The event detector 340 may further be connected to a speech recognition unit 350. A processing circuit 360 may be connected to the microphone 310 and to the event detector 340.

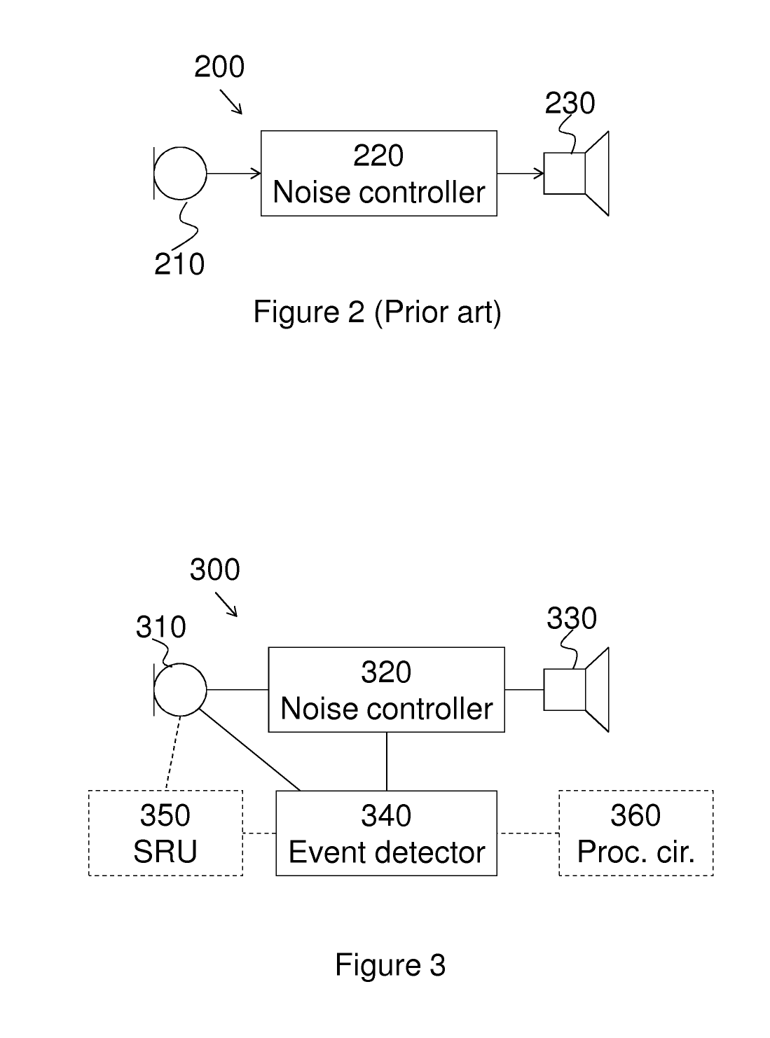

The microphone 310 and the loudspeaker 330 has the same functionality as the microphone 210 and the loudspeaker 230 described in relation to FIG. 2 under the background above. The microphone 310 is preferably arranged at the loudspeaker 330. The microphone 310 is further adapted to forward the first recorded signal to the event detector 340. The noise reducer 300 is adapted to perform a noise reduction process.

The noise reducer 300 may be of either feed forward or feedback type. A feed forward noise reducer 300 records only the surrounding noise using a microphone 310 outside the ear. Feedback headphones records the acoustic wave in the outer ear; the sum of the noise, the anti-noise and a program signal. The program signal may e.g. be a music signal.

The event detector 340 is adapted to detect an external event and send an event detection signal to the noise controller 320. The event detection signal comprises information about the detected external event by the event detector 340. The event detection signal is received by the noise controller 320. The noise controller 320 is adapted to analyze the event detection signal and control the noise reduction process in dependence of the outcome of the analysis.

The external event, detected by the event detector 340 may be several different kinds of events. Below are some non-limiting examples of what the event may be.

The external event may be a sound event where the event detector may detect any kind of sound information. The sound information may be received from the microphone 310. The event detector 340 is adapted to send an event detection signal to the noise controller 320 with information about the external event. The sound event may e.g. be human voice and/or special trigger words. A voice decoder may be used to identify the human voice from the background noise. Such decoders may be included in the noise reducer 300 or may be connected to the noise reducer 300. In e.g. mobile phones such voice decoders are included today. Another sound event may be that a noise level is above a threshold such as alarm or car horn. It will be described below how the noise reducer 300 is adapted to analyze and control the noise reduction process in dependence of the detected events.

According to some embodiments a speech recognition unit 350 may be inserted between the microphone 310 and the event detector 340. The speech recognition unit 350 is adapted to perform a speech recognition process. The speech recognition unit 350 may receive sound information from the microphone 310 and decode the sound information. The decoded sound information is sent to the event detector 340. One external event may be that certain words are decoded by the speech recognition unit 350. This may e.g. be the name of the user. Another external event may be that the speech recognition unit 350 identifies that a certain person is speaking. In yet another external event may be that the speech recognition unit 350 or the event detector 340 identifies any kind of alarm sound that may be essential for the user to receive. Information about the external event may be sent to the noise controller 320 in the event detection signal.

According to some embodiments a processing circuit 360 may be adapted to provide the event detector 340 with information regarding the external event. Some non-limiting examples will be described below in the context that the noise reducer 300 is comprised in a mobile phone but it is obvious to the skilled person that this is not limiting the embodiments. According to some embodiments the external event provided by the processing circuit 360 may e.g. be that the mobile phone receives a phone call. The event may further be that an application in the mobile phone is used. The application provides information about the external event to the event detector 340. The application may e.g. be that the user is reading a text on a display of the mobile phone. Another application may be that the user plays some content in the loudspeakers. The content may e.g. be music, radio or listening to any kind of recording.

Below it will be described how the noise controller may analyze the event detection signal and control the noise reduction process. The noise controller 320 is adapted to analyze the event detection signal based on the physical location of the microphone 310, the physical location of the loudspeaker 330 and physical location of the ear of the user. Depending on the information about the external event in the event detection signal the noise controller 320 is adapted to control the noise reduction process. The noise controller 320 is adapted to send a noise reduction signal to the loudspeaker. The purpose of the noise reduction signal is to cancel out the noise experienced by the user. The noise reduction signal has the same purpose as the second acoustic wave described in the background section. An amplitude of the noise cancellation may be increased or decreased in dependence of the analysis of the external event. To maximize the effect of the noise reducer, the noise cancellation shall be sent with an amplitude so the user receives it with the same amplitude as the background noise. Depending on the event, the noise controller may be turned on or off and also increase or decrease the effect of the noise reduction process by increasing or decreasing the amplitude of the noise reduction signal. The noise reduction signal may be combined with some content played in the loudspeaker 320.

The noise controller 320 is adapted to send the noise reduction signal with a bandwidth comprising a plurality of sub bandwidths. The noise controller 320 is adapted to increase or decrease the amplitude of the noise reduction signal in one or more sub bandwidths in dependence of the information regarding the external event. In the embodiment described above where the external event is a sound event and that a person is speaking, an embodiment may be that the noise reduction process is turned off or that the amplitude of the noise reduction signal is decreased on the sub bandwidths where the person talks. In other embodiments, the external event may be an alarm signal and in those embodiments the amplitude of the noise reduction signal may be decreased in the sub bandwidths where the alarm signal is present. In yet another embodiment the external event may be that the background noise is frequency selective i.e. not the same noise level on all sub bandwidths. In those embodiments the noise controller 320 may increase the amplitude of the noise reduction signal on those sub bandwidths.

The noise reducer 300 may comprise two microphones 310 connected to the noise controller 320, and two loudspeakers 330 connected to the noise controller 320. Preferably one microphone 310 and one loudspeaker 330 should be arranged at each ear of the user.

The noise reducer 300 may be comprised in a portable communication device. The portable communication device may be a mobile phone, a mobile music player.

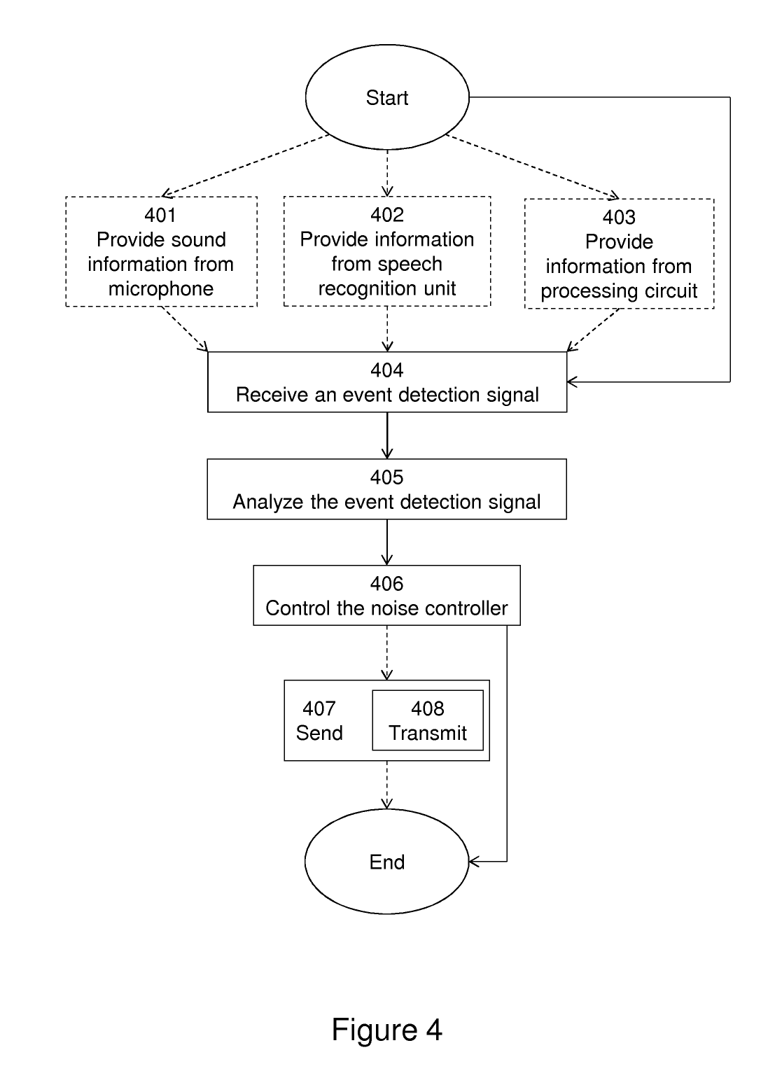

According to some embodiments, a method in a noise reducer 300 for performing a noise reduction process will now be described with reference to FIG. 4.

The method relates to a noise reducer 300 for controlling an active noise reduction process. The noise reducer 300 comprises at least one microphone 310 connected to a noise controller 320, and at least one loudspeaker 330 connected to the noise controller 320. The microphone 310 is arranged at the loudspeaker 330, and the noise controller 320 is adapted to perform the active noise reduction process.

Action 401

In some embodiments the microphone 310 provides the information regarding the external event to the event detector 340. The information about the event may comprise sound information from the microphone 310.

Action 402

This action is an alternative to action 401. In some embodiments the speech recognition unit 350 provides information regarding the external event to the event detector 340. The information about the event may comprise sound information from a speech recognition process performed by the speech recognition unit 350.

Action 403

This action is an alternative to action 401 and 402. In some embodiments the processing circuit 360 provides information regarding the external event to the event detector 340.

Action 404

The noise controller 320 receives an event detection signal from the event detector 340. The event detection signal comprises information regarding an external event. The information indicates what kind of event the event detector 340 has detected. Examples of what the information about the event may be may be found above.

Action 405

To be able to control the active noise reduction process in action 406 the noise controller 320 analyses the event detection signal to decried how the noise reducer 300 should react to the information about the event in the event detection signal.

Action 406

he noise controller 320 controls the active noise reduction process in dependence of an outcome of the analysis of the event detection signal to provide an improved noise reducer 300. The noise reduction process may be controlled in several ways as described above.

Action 407

In some embodiments the noise controller 320 sends a noise reduction signal to the loudspeaker 330; and increases or decreases an amplitude of a noise reduction signal in dependence of the outcome of the analysis of the event detection signal.

Action 408

In some embodiments the noise controller transmits the noise reduction signal with a bandwidth comprising a plurality of sub bandwidths, and increases or decreases the amplitude of the noise reduction signal in one or more sub bandwidths in dependence of the information regarding the external event.

The noise reducer 300 may further comprise a memory comprising one or more memory units. The memory is arranged to be used to receive sound information, analyse the event detection signal, and control the noise reduction signal and applications to perform the methods herein when being executed in the noise reducer 300.

Those skilled in the art will also appreciate that the noise controller 320, the event detector 340, the speech recognition unit 350 and the processing circuit 360 described above may refer to a combination of analog and digital circuits, and/or one or more processors configured with software and/or firmware, e.g. stored in a memory, that when executed by the one or more processors. One or more of these processors, as well as the other digital hardware, may be included in a single application-specific integrated circuit (ASIC), or several processors and various digital hardware may be distributed among several separate components, whether individually packaged or assembled into a system-on-a-chip (SoC).

A computer program product is loadable into a memory of a computer and comprising software code portions adapted for realizing one or more of the features of the noise reducer 300 and/or performing one or more actions of the method described above.

When using the word “comprise” or “comprising” it shall be interpreted as non-limiting, i.e. meaning “consist at least of”.

The embodiments herein are not limited to the above-described preferred embodiments. Various alternatives, modifications and equivalents may be used. Therefore, the embodiments should not be taken as limiting the scope of the invention, which is defined by the appending claims.

1. A noise reducer comprising:
at least one microphone connected to a noise controller, and
at least one loudspeaker connected to the noise controller,
wherein the microphone is arranged at the loudspeaker, and
wherein the noise controller is adapted to perform an active noise reduction process,
wherein the noise reducer is characterized by an event detector connected to the noise controller and adapted to send an event detection signal to the noise controller, and
wherein the event detection signal comprises information regarding an external event, and the noise controller is further adapted to analyse the event detection signal and adapted to control the active noise reduction process in dependence of an outcome of the analysis of the event detection signal.

2. The noise reducer according to claim 1, wherein the microphone is connected to the event detector and
wherein the information regarding the external event comprises sound information from the microphone.

3. The noise reducer according to claim 1, further comprising a speech recognition unit connected to the microphone and to the event detector,
wherein the information regarding the external event comprises information from a speech recognition process performed by the speech recognition unit.

4. The noise reducer according to claim 1, further comprising a processing circuit connected to the event detector and adapted to provide the event detector with information regarding the external event.

5. The noise reducer according to claim 1, wherein the noise controller is further adapted to send a noise reduction signal to the loudspeaker, and to increase or decrease an amplitude of the noise reduction signal in dependence of the analysis of the event detection signal.

6. The noise reducer according to claim 5, wherein the noise reduction signal is transmitted with a bandwidth comprising a plurality of sub bandwidths; and the noise controller is adapted to increase or decrease the amplitude of the noise reduction signal in one or more sub bandwidths in dependence of the information regarding the external event.

7. The noise reducer according to claim 1, wherein the noise reducer comprises two microphones connected to the noise controller, and two loudspeakers connected to the noise controller.

8. A portable communication device comprising a noise reducer according to claim 1.

9. A method in a noise reducer for controlling an active noise reduction process, wherein the noise reducer comprises at least one microphone connected to a noise controller, and at least one loudspeaker connected to the noise controller, wherein the microphone is arranged at the loudspeaker, and wherein the noise controller is adapted to perform the active noise reduction process, the method comprising:
receiving from an event detector an event detection signal, wherein the event detection signal comprises information regarding an external event;
controlling the active noise reduction process in dependence of an outcome of an analysis of the event detection signal.

10. The method according to claim 9, further comprising:
providing, by the microphone that is connected to the event detector, the information regarding the external event to the event detector, and where the information about the event comprises sound information from the microphone.

11. The method according to claim 9, further comprising:
providing, by a speech recognition unit that is connected to the microphone and to the event detector, information regarding the external event to the event detector,
wherein the information about the event comprises sound information from a speech recognition process performed by the speech recognition unit.

12. The method according to claim 9, further comprising:
providing, by a processing circuit connected to the event detector, information regarding the external event to the event detector.

13. The method according to claim 9, wherein controlling further comprises:
sending, by the noise controller a noise reduction signal to the loudspeaker; and
increasing or decreasing an amplitude of a noise reduction signal in dependence of the outcome of the analysis of the event detection signal.

14. The method according to claim 13 wherein sending further comprises:
transmitting the noise reduction signal with a bandwidth comprising a plurality of sub bandwidths; and
increasing or decreasing the amplitude of the noise reduction signal in one or more sub bandwidths in dependence of the information regarding the external event.

15. A computer program product loadable into a memory of a computer and comprising software code portions adapted for realizing one or more of the features of claim 1.

16. A computer program product loadable into a memory of a computer and comprising software code portions adapted for performing one or more actions of claim 9.
